(19) United States
(12) Patent Application Publication
(10) Pub. No.: US 2015/0289000 A1
(43) Pub. Date: Oct. 8, 2015

(54) Programmatic Buying and Selling of Television Advertising

(71) Applicant: CSC HOLDINGS, LLC, Bethpage, NY (US)

(72) Inventors: Thomas Donohue, Putnam Valley, NY (US); Joseph Lovelock, Oceanside, NY (US); Paul Haddad, New York, NY (US)

(21) Appl. No.: 14/533,493

(22) Filed: Nov. 5, 2014

Related U.S. Application Data
(60) Provisional application No. 61/975,279, filed on Apr. 4, 2014.

(51) Int. Cl. H04N 21/2547; H04N 21/24; H04N 21/81

(52) U.S. Cl. CPC H04N 21/2547; H04N 21/812; H04N 21/2407

(57) ABSTRACT

Disclosed herein are system, method, and computer program product embodiments for the programmatic buying and selling television advertisement. An embodiment operates by receiving a request for an available advertising segment inventory meeting one or more criteria. The system transmits to a buyer system available advertising segment inventory meeting the criteria, and receives an offer for the advertising segment including an offer price and a desired date range. The system then performs a comparative analysis of the order with one or more additional received offers for the advertising segment and transmits an offer acceptance notification based on the analysis.

### BACKGROUND

1. Technical Field

This application generally relates to the programmatic buying and selling of television advertising.

2. Background

The purchase and sale of television advertising time typically relies on market analysis methodology that has been in use for many decades. Sales are negotiated based on audience measurement systems, such as the Nielsen ratings system, that sample television program viewership using self-reporting or metering techniques. Television advertisement time providers estimate prices for advertising spots and audience reach using these sampled metrics, and advertisers make purchase decisions based on these estimates.

Current methods of buying and selling advertising time have many drawbacks. The buy-sale workflow relies heavily on manual and disparate sales operations. Additionally, viewership sampling techniques may not always be accurate. For example, self-reported viewership information may be biased and audience samples may not be statistically random. Moreover, demographic audience information may be limited.

While Internet-based advertising has made progress in incorporating programmatic methods of audience discovery and targeted marketing, television advertising has additional challenges that complicates adoption of a programmatic model.

### SUMMARY

Accordingly, it would be advantageous to provide a mechanism for the programmatic buying and selling of television advertisements.

In an embodiment, a system receives a request for an available advertising segment inventory meeting one or more criteria. The system transmits to a buyer system available advertising segment inventory meeting the criteria, and receives an offer for the advertising segment including an offer price and a desired date range. The system then performs a comparative analysis of the order with one or more additional received offers for the advertising segment and transmits an offer acceptance notification based on the analysis.

Method and computer-readable medium embodiments are also disclosed.

Further embodiments and features, as well as the structure and operation of the various embodiments, are described in detail below with reference to accompanying drawings.

### BRIEF DESCRIPTION OF THE DRAWINGS

The accompanying drawings are incorporated herein and form a part of the specification.

FIG. 1 is a block diagram illustrating a networked environment implementing the programmatic buying and selling of television advertising, according to an example embodiment.

FIG. 2 illustrates the workflow for the programmatic buying of television advertising and the associated data exchange between buyers and sellers, according to an example embodiment.

FIG. 3 is a block diagram illustrating further details of a networked environment implementing the programmatic buying and selling of television advertising, according to an example embodiment.

FIGS. 4A-D illustrate requests and function calls associated with various stages of the automated buying and selling of advertising spots, according to an example embodiment.

FIG. 5 is a flowchart illustrating a method for conducting programmatic trading of video advertising inventory, according to an example embodiment.

FIG. 6 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

While digital advertising may take advantage of programmatic functions in advertising sales, programmatic television advertising has failed in part because of challenges involved in sharing audience information. Solutions for television advertising trading may rely on sharing of raw audience and impression data. However, sharing raw data may be inefficient due to the large amount of data and may be undesirable by video programming distributors who have an interest in minimizing the amount of audience data shared.

Embodiments disclose a mechanism for the programmatic buying and selling of advertisement segments that allows distributors to offer segments based on a desired audience reach and an estimated budget.

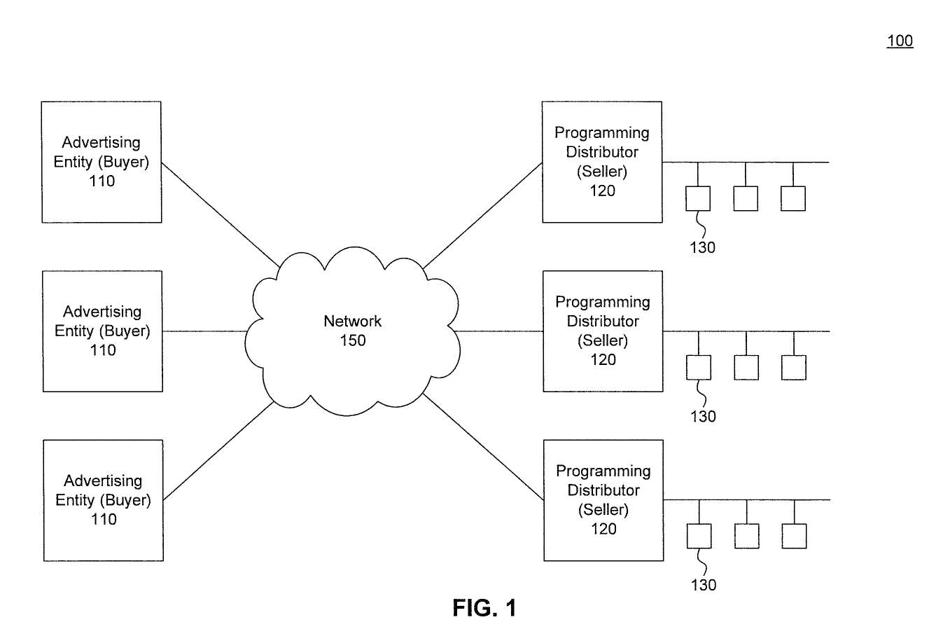

FIG. 1 is a block diagram illustrating a networked environment 100 implementing the programmatic buying and selling of television advertising, according to an example embodiment. Networked environment 100 includes advertising entities 110 and television programming distributors 120 in communication through network 150. Advertising entities 110 may be, for example, television advertising agencies. Television programming distributors 120 may be, for example, multichannel video distribution systems, cable television providers, satellite television providers, etc. Network 150 may be any data communications network, such as the Internet.

Advertising entities 110 engage in buying advertising time from programming distributors 120. For simplicity of explanation, advertising entities 110 will be hereafter referred to as advertising time buyers 110 (or simply buyers 110) and programming distributors 120 will be referred to as advertising time sellers 120 (or simply sellers 120).

Advertising time sellers 120 provide video programming to consumers 130. Consumers 130 may be, for example, cable or satellite television consumers receiving multichannel video programming through a set-top box.

Sellers 120 measure and maintain information associated with audiences and viewership statistics of the provided video programming. For example, sellers 120 may collect raw data regarding audience impressions (or number of views) for advertisements shown at particular times, geographic regions, television networks, programming types, particular programs, etc. Sellers 120 then use this data to offer and sell advertising spots to buyers 110. In an embodiment, buyers 110 and sellers 120 communicate using a programmatic planning and trading protocol that performs advertisement time sales in an automated manner.

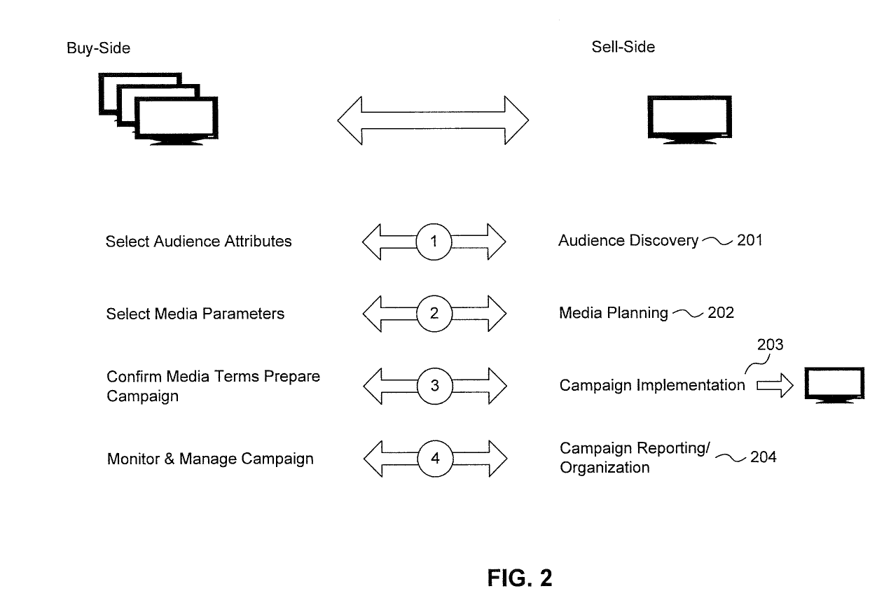

FIG. 2 describes the workflow for the programmatic buying of television advertising and the associated data exchange between buyers and sellers, according to an example embodiment. FIG. 2 describes four workflow components that can be effective in the implementation of a successful programmatic model for the buying of advertising spots: audience discovery 201, media planning 202, campaign implementation 203, and reporting and optimization 204.

Audience discovery 201 relates to defining target audience segments. In an embodiment, buyers may provide sellers with key audience attributes that define their target audience. The attributes may include demographics (e.g., gender, age, ethnicity, language, location), psychographics (e.g., personality, values, opinions, attitudes, interests, lifestyles), client list matches, etc. Sellers 120 may perform audience discovery based on the provided attributes using collected data to create a target list of households that constitute the target segment. For example, a target segment may comprise households with a viewer age range between 18-49, another segment may comprise households with an income of $50,000 or more, and another segment may comprise households with viewers that frequently travel internationally.

Media planning 202 relates to identifying networks and dayparts to reach a target segment. Dayparts are divisions of the day associated with target audiences that typically engage at that time. Examples of dayparts may be early morning (e.g., 6-10 AM), daytime (10 AM-4:30 PM), prime time (8-11 PM), etc. Media planning may involve analyzing a buyer's preferred media type, buyer-provided campaign parameters, and advertising inventory availability. Media types may include running of commercials linearly or addressable to particular households, where each household could receive individually targeted advertisements. Buyer-provided campaign parameters may include flight (i.e., timing pattern for running advertisements), budget, number of targeted impressions, required geographic reach, frequency, etc.

Once the seller 120 identifies target segments, and networks and dayparts to reach that target segment, the seller 120 initiates the campaign implementation 203 component. Campaign implementation relates to executing actions for receiving orders and advertising media, determining inventory availability, determining and communication offer acceptance, inserting commercials into the video programming, etc.

Reporting and optimization 204 relates to providing buyers with reports and various campaign related data. Data may be used to perform analytics on the results of the media plan, such as matchback, return on investment, etc. These analytics may be used to optimize the results of campaigns for buyers or the revenues from advertising spot sales for sellers.

In an embodiment, buyers 110 and sellers 120 exchange information using a protocol for the automated buying and selling of advertising spots to perform the workflow described above. Buyers 110 may provide audience attributes and media parameters to sellers 120. For example, a buyer 110 may provide a desired number of impressions, a television network and an estimated budget. Sellers 120 may perform an analysis of the available inventory and provide buyer 110 with an available advertising segment that meets the criteria and an estimated price. Buyer 110 may provide seller 120 an offer for the advertising segment at a price and for a date range. Sellers 120 may receive multiple offers from multiple buyers 110, and may perform a comparative analysis of the offers to determine which to accept. For example, a seller 120 may wish to maximize revenues, and may perform an optimization analysis of the offers to accept the ones that maximize revenue.

Buyers and sellers may use a common protocol that provides functionalities to perform the request/response negotiation for advertising trading. The protocol may be implemented in, for example, Extensible Markup Language (XML), Simple Object Access Protocol (SOAP), Representational state transfer (REST), etc.

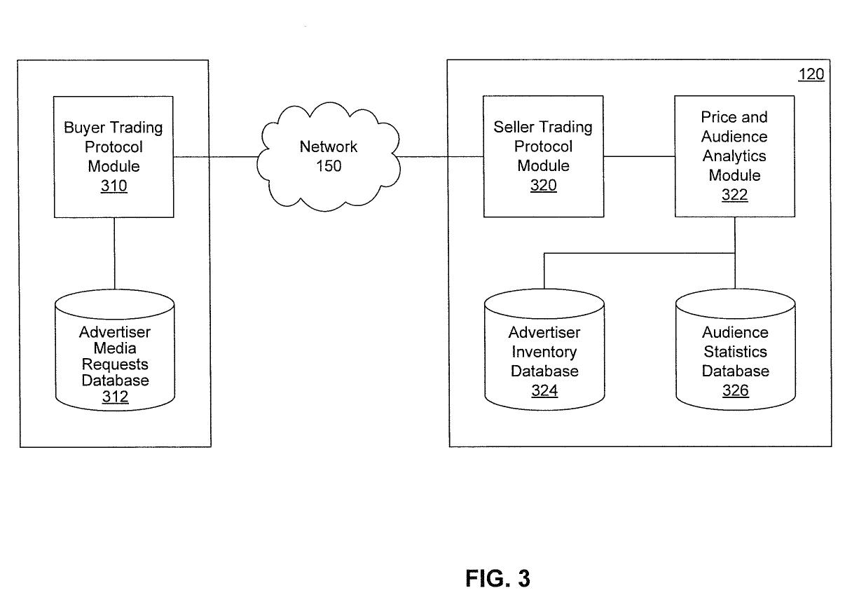

FIG. 3 is a block diagram illustrating further details of a networked environment 100 implementing the programmatic buying and selling of television advertising, according to an example embodiment.

A buyer 110 system may include a buyer trading protocol module 310 and an advertiser media requests database 312. A seller 120 system may include a seller trading protocol module 320, a price and audience analytics module 322, an advertising inventory database 324 and an audience statistics database 326.

A buyer trading protocol module 310 may implement the buyer side of a protocol for performing programmatic buying and selling of television advertising. The buyer trading protocol module 310 may provide information regarding desired audience impressions, estimated budget or targeted demographics, and receive information regarding available inventories and pricing. Based on this information, the buyer 110 system can make advertising time buying decisions based on, for example, relevant audience impressions and cost. In an embodiment, buyer 110 system makes real-time decisions and purchasing actions in an automated manner. In an embodiment, buyer 110 system makes recommendations for a human actor to make purchasing decisions.

Buyer module 310 may communicate with advertiser media requests database 312. Database 312 may store information regarding advertisers' requirements for advertising time, such as target demographics, budgets, etc.

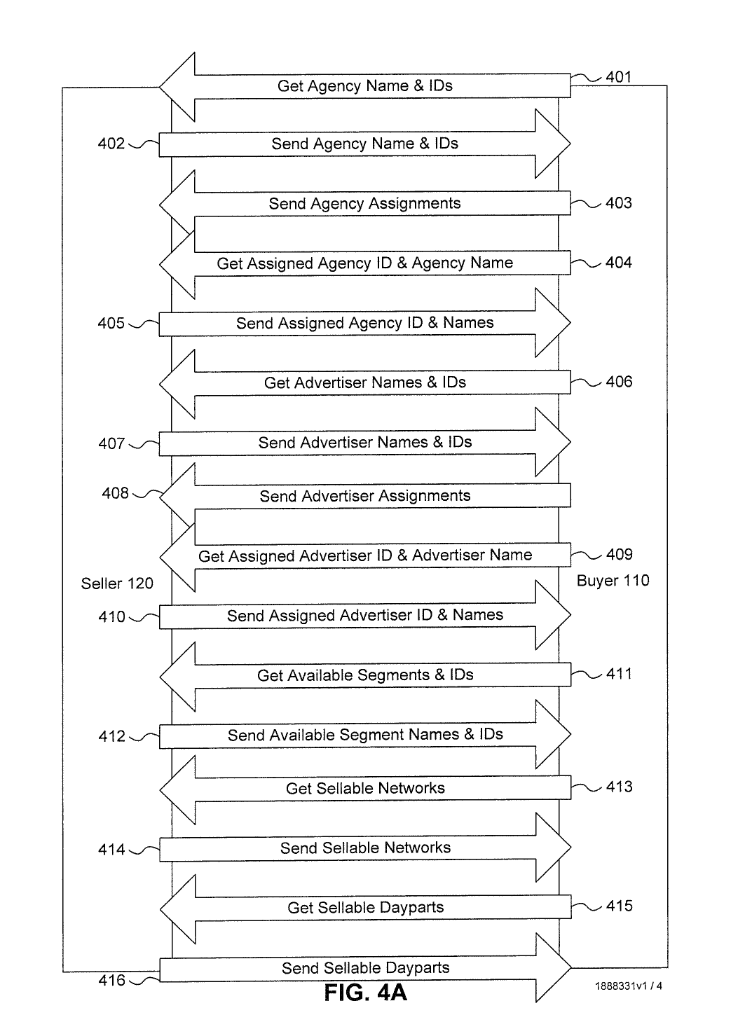

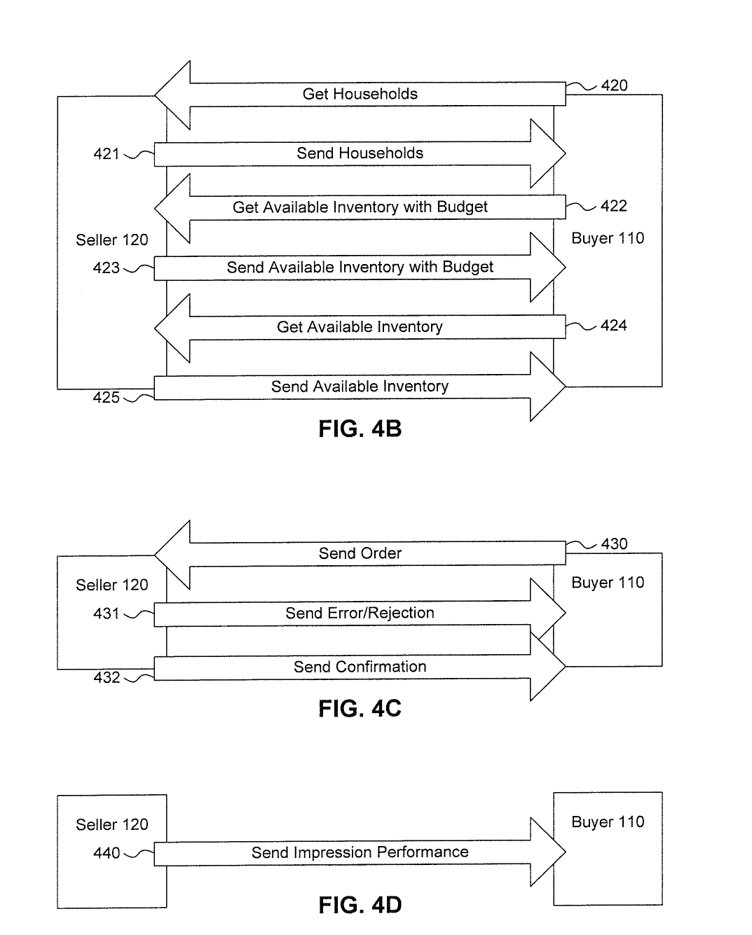

A seller trading protocol module 320 may implement the seller side of a protocol for performing programmatic buying and selling of television advertising. The seller trading protocol module 320 may receive information regarding desired audience impressions, estimated budget or targeted demographics, and provide available inventories and pricing. Module 320 may also receive offers from buyers 110, and send acceptance or rejection messages in response. FIGS. 4A-D, described below, explain additional details of buyer and seller trading protocol modules 310 and 320.

Price and audience analytics module 322 may analyze audience information to determine market segments that target particular demographics. For example, analytics module 322 may obtain seller 120 customer survey data and viewership information and perform a statistical analysis to determine television shows that audiences in the age range of 18-25 watch. Based on this analysis, analytics module 322 creates an age 18-25 segment that seller 120 can offer for sale to advertisers looking to target that age range.

Module 322 may obtain audience information from audience statistics database 326. Statistics database 326 may maintain statistics on viewership for networks, programs, dayparts, etc. The statistics may allow a seller 120 to determine, for example, the dayparts with the most viewership for particular demographics and psychographics.

Price and audience analytics module 322 may also determine prices for segments based on buyer demand and inventory information. For example, module 322 may analyze various offers for segments from multiple buyers 110, and may determine which ones to accept and reject order to maximize revenues or to maintain an available supply of segments. Module 322 may obtain inventory information from advertising inventory database 324. In an embodiment, module 322 performs automated analysis and selling actions in real-time. In an embodiment, module 322 gives recommendations to a human actor that makes selling decisions and performs selling actions.

FIGS. 4A-D illustrate requests and function calls associated with various stages of the automated buying and selling of advertising spots, according to an example embodiment. A trading protocol 400 may provide function calls for buyers and sellers to communicate, exchange inventory information, and conduct transactions.

FIG. 4A shows an example setup stage data exchange. The setup stage may be initiated by an advertisement agency (e.g., John Doe Advertising Agency LLC). Agencies may negotiate the buying and selling of advertising spots on behalf of one or more advertisers. Advertisers may be companies or organizations looking to advertise their products or services (e.g., Coca Cola®, Ford®, Apple®).

In an embodiment, a buyer 110 may register an account, where the account is associated with one or more agencies and advertisers. A buyer 110 may transact with seller 120 using a user identifier associated with the account, which may in turn be associated with one or more agency identifiers and one or more advertiser identifiers. A seller 120 may provide buyer 110 with the user identifier, or may the buyer 110 to provide the user identifier. In an embodiment, the seller 120 may use these identifiers to authenticate communications with the buyer 110.

Function 401 “Get Agency Names & IDs” may allow a buyer 110 to request from a seller 120 a list of all agency names and corresponding agency identifiers for agencies registered with the seller. A seller 120 can use function 402 “Send Agency Names & IDs” to respond to the buyer's function 401 request with a list of agency names and corresponding agency identifiers.

Function 403 “Send Agency Assignments” may allow a buyer 110 to send a list of agency names and agency identifiers for registering in association with buyer 110's user identifier.

Function 404 “Get Assigned Agency ID and Agency Name” may allow a buyer 110 to request from a seller 120 a list of all agency names and corresponding agency identifiers for agencies associated with the buyer's user identifier. A seller 120 can use function 405 “Send Assigned Agency IDs & Names” to respond to the buyer's function 404 request with a list of agency names and corresponding agency identifiers associated with the user identifier.

Function 406 “Get Advertiser Names & IDs” may allow a buyer 110 to request from a seller 120 a list of all advertiser names and corresponding advertiser identifiers for advertisers registered with the seller. A seller 120 can use function 407 Send Advertiser Names & IDs to respond to the buyer's function 406 request with a list of advertiser names and corresponding advertiser identifiers.

Function 408 “Send Advertiser Assignments” may allow a buyer 110 to send a list of advertiser names and advertiser identifiers for registering in association with buyer 110's user identifier.

Function 409 Get Assigned Advertiser ID and Advertiser Name” may allow a buyer 110 to request from a seller 120 a list of all advertiser names and corresponding advertiser identifiers for advertisers associated with the buyer's user identifier. A seller 120 can use function 410 “Send Assigned Advertiser IDs & Names” to respond to the buyer's function 409 request with a list of advertiser names and corresponding advertiser identifiers associated with the user identifier.

Setup function calls may also include calls for exchanging additional information between the buyers and sellers. A buyer 110 may request information about available target market segments, available networks and dayparts for sale, as shown in functions 411-416.

FIG. 4B shows example function calls for exchanging audience discovery information. For example, a buyer 110 may use a function 420 “Get Households” to request a count of households associated with an target market segment. Other calls may include functions 422 and 424 “Get Available Inventory” calls, which may request not-yet-sold segment inventory that meets certain criteria, such as desired networks, networks to exclude, dayparts desired, dayparts to exclude, date range, estimated budget, etc. Sellers 120 may use corresponding function 421 “Send Households” and functions 423 and 425 “Send Available Inventory” calls to respond to buyer's requests. An available inventory response may include a budget or impressions estimate and an estimate identifier that the buyer may use to submit an offer based on the estimate.

The exchange of inventory, budget and pricing estimates may occur in various ways. In an embodiment, a function 422 “Get Available Inventory with Budget” call may include an estimated budget, requesting a seller 120 to provide a number of impressions that the seller can provide for that budget. The seller may also provide an estimate of how the number of impressions may be provided during the date range by, for example, indicating how many impressions will be delivered per week. The seller 120 may then use the function 423 “Send Available Inventory with Budget” call to send the number of impressions that it can provide for that budget. In an embodiment, the function 424 “Get Available Inventory” call may include a desired number of impressions, and requesting a seller 120 to provide an estimated price for the number of impressions. The seller 120 may then use the function 425 “Send Available Inventory” call to send the price. In an embodiment, the “Get Available Inventory” call may include a desired number of impressions and an estimated budget, requesting a seller 120 to indicate whether there is available inventory that meets or is close to these parameters.

In an embodiment, a buyer 110 may also use a function that provides both a estimated budget and a desired number of impressions. The seller 120 may then use a corresponding function to return a “yes or no” answer of whether it can provide the desired number of impressions at the estimated budget.

FIG. 4C shows example function calls for placing and accepting orders. In an embodiment, a buyer 110 uses a function 430 “Send Order” call to submit an offer to buy a segment for a date range at an offer price. The order may be tied to a previous estimate by using an estimate number. A seller 120 may respond with a function 431 “Send Error” call or a function 432 “Send Confirmation” call. The 431 “Send Error” call may indicate that error with the 430 “Send Order” call, such as an estimate number that does not match an estimate price or segment. The 432 “Send Confirmation” call may indicate whether the seller 120 accepts or declines the offer.

FIG. 4D illustrates a 440 “Send Impression Performance” function call for sending performance data. A seller 120 may record performance statistics, such as daily, weekly, monthly, etc., impressions for a buyer's purchased segments, and transmit the performance data to the buyer.

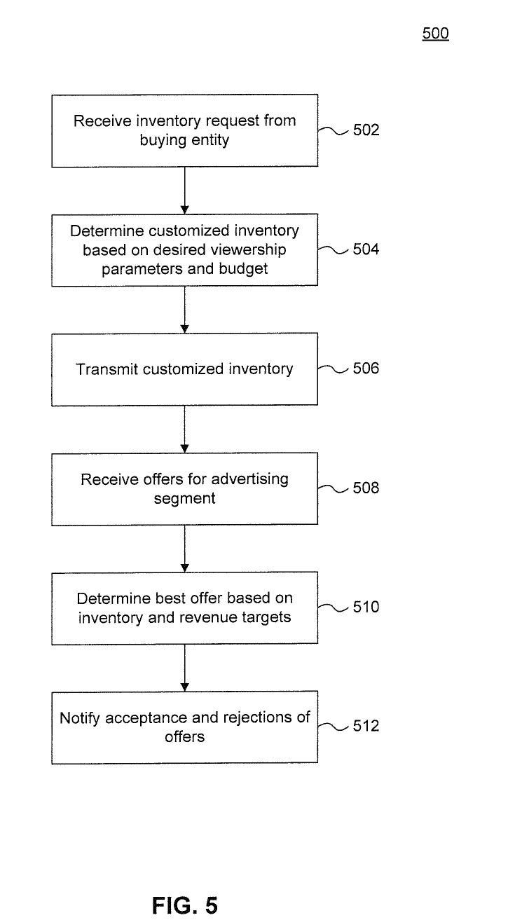

FIG. 5 is a flowchart illustrating a method for conducting programmatic trading of video advertising inventory, according to an example embodiment.

At step 502, an advertising spot seller receives an available inventory request from a buyer. The inventory request may include criteria for the inventory, such as a date range, number of desired impressions or an estimated desirable budget. As explained, an inventory request may request a price estimate for a desired number of impressions, or may request a number of impressions that the seller is willing to provide for a set price.

At step 504, the seller determines an available inventory that matches the buyer's criteria. For example, the seller may determine dayparts and pricing for the buyer based on the buyer's criteria. The seller may also determine an available inventory based on additional criteria that may enable sellers to achieve goals, such as, for example, maximize revenues. In an embodiment, the seller analyzes current or historical offers from multiple sellers to determine prices that may maximize revenue.

At step 506, the seller transmits the determined inventory to the buyer. The inventory may be tied to a particular estimate identifier and include a price. The inventory may also include a number of impressions available at the price suggested by the buyer.

At step 508, the seller receives offers for advertising segments from one or more buyers. In an embodiment, the offer must match a previous estimate identifier and associated price to be valid. The seller may wait for a time period, or for a certain number of offers for the segment, before accepting an offer. When receiving multiple offers for a segment, the seller determines which offer to accept based on a comparative analysis of the offers. For example, the seller may select the offer that maximizes revenues.

At step 510, the seller notifies the buyer that the offer has either been accepted or rejected.

### Example Computer System

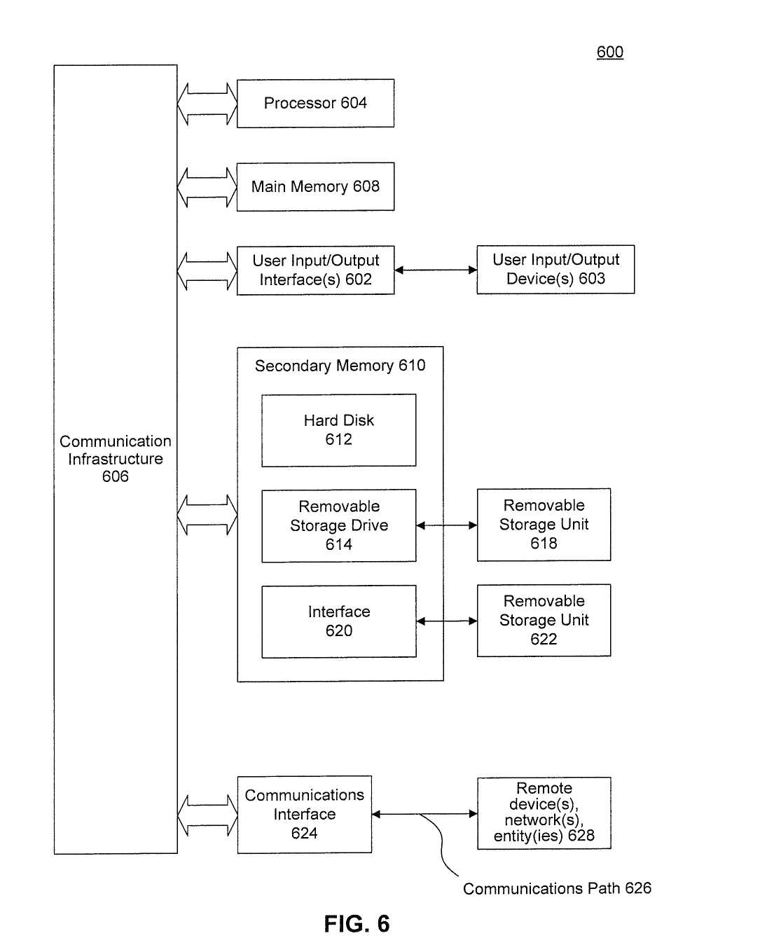

Various embodiments can be implemented, for example, using one or more well-known computer systems, such as computer system 600 shown in FIG. 6. Computer system 600 can be any well-known computer capable of performing the functions described herein, such as computers available from International Business Machines, Apple, Sun, HP, Dell, Sony, Toshiba, etc.

Computer system 600 includes one or more processors (also called central processing units, or CPUs), such as a processor 604. Processor 604 is connected to a communication infrastructure or bus 606.

Computer system 600 also includes user input/output device(s) 603, such as monitors, keyboards, pointing devices, etc., which communicate with communication infrastructure 606 through user input/output interface(s) 602.

Computer system 600 also includes a main or primary memory 608, such as random access memory (RAM). Main memory 608 may include one or more levels of cache. Main memory 608 has stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to an exemplary embodiment, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

In an embodiment, a tangible apparatus or article of manufacture comprising a tangible computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 6. In particular, embodiments may operate with software, hardware, and/or operating system implementations other than those described herein.

What is claimed is:

1. A computer-implemented method of selling an advertising segment by a video programming distributor, comprising:
receiving, from a buyer system, a request for an available advertising segment inventory meeting one or more criterion;
transmitting, to the buyer system, the available advertising segment inventory meeting the one or more criterion;
receiving, from the buyer system, an offer for the advertising segment, the offer comprising an offer price and a desired date range;
performing a comparative analysis of the order with one or more additional received offers for the advertising segment; and
transmitting, to the buyer system, an offer acceptance notification based on the comparative analysis.

2. The method of claim 1, wherein the comparative analysis comprises estimating whether the offer maximizes revenue based on the additional received offers.

3. The method of claim 1, wherein the one or more criterion comprises at least one of a desired number of impressions and an estimated budget.

4. The method of claim 3, wherein the transmitting the available advertising segment comprises transmitting at least one of an estimated price associated with the desired number of audience impressions and an estimated number of impressions associated with the estimated budget.

5. The method of claim 3, wherein the one or more criterion further comprises at least one of a network to exclude and a daypart to exclude.

6. A computer-implemented method of buying an advertising segment from a video programming distributor, comprising:
transmitting, to the distributor, a request for an available advertising segment inventory meeting one or more criterion;
receiving, from the distributor, the available advertising segment inventory meeting the one or more criterion and an estimated price;
performing an analysis to determine an offer based on the available advertising segment inventory, the offer comprising an offer price and a desired date range;
transmitting, to the distributor, the offer for the advertising segment; and
receiving, from the distributor, an offer acceptance notification.

7. The method of claim 5, wherein the analysis comprises estimating an offer that optimizes relevant audience impressions and cost.

8. The method of claim 5, wherein the one or more criterion comprises at least one of a desired number of audience impressions and an estimated budget.

9. The method of claim 8, wherein the receiving the available advertising segment inventory comprises receiving at least one of an estimated price associated with the desired number of audience impressions and an estimated number of impressions associated with the estimated budget.

10. The method of claim 8, wherein the one or more criterion further comprises at least one of a network to exclude and a daypart to exclude.

11. A system for buying an advertising segment from a video programming distributor, comprising:
a processor and a memory configured to implement:
a trading protocol module that:
transmits, to the distributor, a request for an available advertising segment inventory meeting one or more criterion, and
receives, from the distributor, the available advertising segment inventory meeting the one or more criterion and an estimated price, and
an analytics module that:
performs an analysis to determine an offer based on the available advertising segment inventory, the offer comprising an offer price and a desired date range,
wherein the trading protocol module further transmits, to the distributor, the offer for the advertising segment and receives, from the distributor, an offer acceptance notification.

12. The system of claim 11, wherein the analysis comprises estimating an offer that optimizes relevant audience impressions and cost.

13. The system of claim 11, wherein the one or more criterion comprises at least one of a desired number of audience impressions and an estimated budget.

14. The system of claim 13, wherein the receiving the available advertising segment inventory comprises receiving at least one of an estimated price associated with the desired number of audience impressions and an estimated number of impressions associated with the estimated budget.

15. The system of claim 11, wherein the advertising segment inventory data comprises a number of audience impressions per date range.

16. A non-transitory computer-readable medium having instructions stored thereon that, when executed by at least one computing device, causes the at least one computing device to perform operations for buying an advertising segment from a video programming distributor, the operations comprising:
transmitting, to the distributor, a request for an available advertising segment inventory meeting one or more criterion;
receiving, from the distributor, the available advertising segment inventory meeting the one or more criterion and an estimated price;
performing an analysis to determine an offer based on the available advertising segment inventory, the offer comprising an offer price and a desired date range;
transmitting, to the distributor, the offer for the advertising segment; and
receiving, from the distributor, an offer acceptance notification.

17. The computer-readable medium of claim 16, wherein the analysis comprises estimating an offer that optimizes relevant audience impressions and cost.

18. The computer-readable medium of claim 15, wherein the one or more criterion comprises at least one of a desired number of audience impressions and an estimated budget.

19. The computer-readable medium of claim 18, wherein the receiving the available advertising segment inventory comprises receiving at least one of an estimated price associated with the desired number of audience impressions and an estimated number of impressions associated with the estimated budget.

20. The computer-readable medium of claim 18, wherein the one or more criterion further comprises at least one of a network to exclude and a daypart to exclude.
